(19) United States
(12) Patent Application Publication
(10) Pub. No.: US 2022/0106202 A1
(43) Pub. Date: Apr. 7, 2022

(54) MULTICOLUMN FILTRATION SYSTEM FOR PROCESSING INDUSTRIAL WASTEWATER

(71) Applicant: HydrEra Holdings Corp., Calgary (CA)

(72) Inventors: Josh Storey, Hixon (CA); Denvor Smith, Grande Prairie (CA)

(73) Assignee: HydrEra Holdings Corp., Calgary, AB (CA)

(21) Appl. No.: 17/428,443

(22) PCT Filed: Feb. 5, 2020
(86) PCT No.: PCT/CA2020/050141

§ 371 Date: Aug. 4, 2021

Related U.S. Application Data
(60) Provisional application No. 62/801,567, filed on Feb. 5, 2019.

(51) Int. Cl. C02F 1/00; C02F 1/44

(52) U.S. Cl. CPC C02F 1/004; C02F 1/441; C02F 2201/007; C02F 2103/10; C02F 2209/03; C02F 2209/40; C02F 2301/043; C02F 2201/008

(57) ABSTRACT

Disclosed herein is a multicolumn filtration assembly for processing industrial wastewater. The multicolumn filtration assembly comprises: (i) a water inlet tee element interconnected with a bypass line and a water outlet manifold; (ii) a valve interposed the water inlet tee element and the bypass line; (iii) a water inlet manifold interconnected with the bypass line; and (iii) a plurality of water filtration columns interposed the water inlet manifold and the water outlet manifold wherein each of the plurality of water filtration columns has a first valve for controlling water inflow from the water inlet manifold and a second valve for controlling water outflow into the water outlet manifold. Also disclosed are multistage multicolumn fluid filtration systems and fluid treatment systems comprising multicolumn filtration assemblies.

### FIELD

The present disclosure generally relates to fluid filtration apparatus for high-throughput processing of fluids. More particularly, the present disclosure pertains to assemblies comprising multiple inline filtration columns connected in parallel to a fluid inlet manifold and a fluid outlet manifold.

### BACKGROUND

Many industries produce waste fluids that may require filtration before being recycled for reuse or usable for other applications or industries. For example, industries such as oil and gas, mining, agriculture, or applications such as industrial, civil, and natural disaster relief may produce a variety of fluids that require filtration. Such fluids may include but are not limited to produced water, wastewater, brine water, fresh water, and the like.

For example, hydraulic fracking operations to fracture subterranean shale and other tight rock formations typically use fracking fluid compositions for high-pressure injection at the front end of the operations to cause fracturing of the subterranean formations to release oil and gas deposits that are trapped therein. The back end of fracking operations includes capture and collection of spent flow-back water that generally is a mixture of fracking fluids and formation water released from the fractured rock formation. Formation water is typically rich in brines comprising salts, hydrocarbons, and in some cases, heavy metals and/or naturally occurring radioactive materials. The mixtures of spend fracking fluids and formulation water are commonly referred to as “produced water” and additionally include suspended solids and particulate matter resulting from the fracturing events. Consequently, produced water typically has significant viscosities.

Large volumes of produced water i.e., wastewater, are generated during fracking operations, and complex processing systems and equipment are required to: (i) collect and store produced water in sealed settling ponds or in above and/or below-ground reservoirs to prevent leakage of produced water into the surrounding terrain and water ways, and (ii) process the produced water to make it suitable for recycling back into the front end of fracking operations as a fracking fluid component. Produced water recovered from fracking operations typically goes through three stages water treatment to reduce its viscosity and contaminants to make it suitable for recycling back into the front end fracking fluid compositions. The first treatment stage, also commonly referred to as a pretreatment stage, is the use of settling ponds and/or in-ground reservoirs and/or above-ground reservoirs for passive removal of large oil droplets, coarse particles, charged particles, and gas bubbles from the produced water. Strainers and/or skimmers may also be used with the settling ponds/reservoirs to reduce the time that produced water has to remain in the pretreatment stage.

The second water treatment stage, also commonly referred to as the primary treatment stage, commonly involves the sequential use of several different types of equipment for removal of smaller drops of oils and related hydrocarbons from pretreated produced water, for example API oil-water separating tanks, plate-pack interceptors, and the like, followed by removal of smaller particulate matter with pressurized equipment such as hydrocyclones, centrifuges, and the like. Although produced water coming out the second i.e., primary water treatment stage has a reduced viscosity in comparison produced water captured and collected from the back end of fracking processes, the viscosity of primary-treated produced water typically is significantly higher than is acceptable for its recycling back to the front-end re-injection process steps.

Therefore, primary-treated produced water is put through a third step commonly referred to as a clean-up step or alternatively as a polishing step wherein the primary-treated water is passed through filtration equipment comprising one of dual media filters, cartridge filters, membranes filters, and the like, to remove suspended microparticulates and dispersed organic microaggregates. The filtration equipment is configured for easy onsite access to insert and remove the filtration media. The challenge for treatment and recycling of produced water on fracking operation sites is to move it through the three stages as quickly as possible and consequently, primary-treated water often contains significant amounts of larger suspended particulates that consequently clog up the filtration media and significantly slow or stop of the flow of water through the third clean-up polishing step. Consequently, it is common to use filter pots that may house six (e.g., a 3-ft dia. pot) or eight or ten or twelve (e.g., a 4-ft dia. pot) cartridge filters to increase the time available for water throughput before the multiple filter cartridges in a filter pot become plugged. The problem is that when the filter cartridges become plugged to the point where waterflow is significantly restricted, the filtration equipment has to be shutdown, the filter pots opened, the clogged filter cartridges removed and replaced with clean cartridges, the filter pots closed and resealed, and then the flow of water restarted. In most hydraulic fracking operations, the flow of primary-treated produced water through the third clean-up polishing equipment typically requires shutdown and service of the filtration equipment at four to six hours of operation, thereby significantly reducing the throughput and output of the fracking operations.

Similar issues may arise during operations in other industries or applications. As a further example, during mining operations (e.g. the extraction of minerals from ore), tailings are produced. Tailings are the materials left over after separating the fractions of an ore. In general, the extraction of minerals from ore is conventionally done by placer mining, which uses water and gravity to concentrate the minerals, or by hard rock mining, which pulverizes the rock containing the ore and then uses chemical reactions to concentrate the minerals. In the latter method, the extraction of minerals from ore requires comminution, i.e., grinding the ore into fine particles to facilitate extraction of the target minerals. As a result of comminution, the tailings produced may include a slurry comprising solids, fine particles, and a fluid. The fluid may be one used to facilitate the chemical reactions that concentrate the minerals. The tailings may, therefore, and like the produced water described above, have significant viscosities and require significant filtration. Filtration of such tailings may result in the same problems described above, e.g., filter cartridges becoming plugged and thus requiring the halting of the filtration processes so that the cartridges may be replaced.

In another example, natural disasters (e.g. hurricanes, earthquakes, tsunamis, etc.) may render wells and public water supplies undrinkable. The natural disasters may cause runoff that washes, for example, chemicals such as pesticides and solvents, solid contaminants, and raw sewage from failed septic systems into aquifers. Such contaminants may cause both short-term illness and long-term chronic disease if consumed. Further, the contaminated water may have a significant turbidity resulting from the presence of mud, organic matter, or various sediments therein. While the turbidity itself may not be dangerous, high turbidity is often associated with the presence of microorganisms. Reverse osmosis, UV treatments, boiling, and/or chemicals are often employed to kill such microorganisms. However, the presence of excess particulate (i.e. in high-turbidity conditions) may hinder the effectiveness of such treatments. Thus, contaminated water may be initially subjected to filtration processes. The filtration processes, as a result of the high turbidity of the contaminated waters, may afford the same issues as previously described herein (e.g. filter cartridges becoming plugged and thus requiring the halting of the filtration processes so that the cartridges may be replaced).

Thus, it is clear that many industries and applications involve the high-throughput filtration of fluid using equipment that may require significant downtime to service, for example, in the event of a blockage.

### SUMMARY

The embodiments of the present disclosure generally relate to multicolumn filtration apparatus and assemblies for high-volume throughput and processing of fluids. The multicolumn filtration apparatus and assemblies disclosed herein enable isolation, shutdown, and service of one or more columns while the remaining columns remain in operation.

One embodiment disclosed herein pertains to a multicolumn fluid filtration assembly comprising (i) a fluid inlet tee element interconnected with a bypass line and a fluid outlet manifold; (ii) a valve interposed the fluid inlet tee element and the bypass line; (iii) a fluid inlet manifold interconnected with the bypass line; and (iii) a plurality of fluid filtration columns interposed the fluid inlet manifold and the fluid outlet manifold wherein each of the plurality of fluid filtration columns has a first valve for controlling fluid inflow from the fluid inlet manifold and a second valve for controlling fluid outflow into the fluid outlet manifold. Each of the plurality of fluid filtration columns is configured for quick access to insert and recover a replaceable filter cartridge.

Operation of this embodiment involves first, sealable engagement with a supply of primary-treated industrial wastewater, and the diverting the flow of fluid (e.g. wastewater, produced water, etc.) into the bypass line and into the fluid inlet manifold. The fluid then flows through the plurality of water filtration columns wherein suspended particulates are removed, and then into a fluid outlet manifold that delivers the filtered fluid into an external outlet line. When one or more of the filter cartridges housed in the plurality of fluid filtration columns becomes saturated with filtered-out particulates to the point where the flow of fluid therethrough is significantly reduced or stopped, the affected fluid filtration column can be isolated and taken offline by closing its first and second valves. The end cap of the fluid filtration column can then be removed, the particulate-saturated filter cartridge removed and replaced with a fresh filter cartridge after which, the end cap is sealably reinstalled onto the fluid filtration column. The serviced fluid filtration column can then be put back into operation by opening its second and first valves. It is to be noted that one or more individual fluid filtration columns can be taken offline and serviced whilst the remaining plurality of fluid filtration columns remain in operation. This configuration avoids having to completely stop fluid treatment operations to replace clogged filter cartridges in a filter pot.

The multicolumn fluid filtration assemblies disclosed herein can be mounted onto transportable skids whereby the assemblies can be moved from jobsite to jobsite as required. The transportable skids may be mounted onto the frameworks of heavy-duty over-road trucks or onto the decks of trailers that are towable by trucks, for example 1-ton trucks, heavier-duty trucks, and heavy-duty truck tractors.

Another embodiment of the present disclosure pertains to a multicolumn filtration assembly wherein a fluid inlet tee element is sealably engaged with two bypass lines. The first bypass line is interconnected with a first fluid inlet manifold which in turn, is interconnected with a first plurality of fluid filtration columns. The first plurality of fluid filtration columns is interconnected with a first fluid outlet manifold. Each of the plurality of fluid filtration columns has a first valve for controlling fluid inflow from the first fluid inlet manifold and a second valve for controlling fluid outflow into the first fluid outlet manifold. The second bypass line is interconnected with a second fluid inlet manifold which in turn, is interconnected with a second plurality of fluid filtration columns. The second plurality of fluid filtration columns is interconnected with a second fluid outlet manifold. Each of the second plurality of fluid filtration columns has a first valve for controlling fluid inflow from the second fluid inlet manifold and a second valve for controlling fluid outflow into the second fluid outlet manifold. A first valve is interposed the fluid inlet tee element and the first bypass line, and a second valve is interposed the fluid inlet tee element and the second bypass line.

Another embodiment of the present disclosure pertains to a multicolumn filtration assembly wherein the fluid inlet tee element is interconnected with two bypass lines. A first bypass line is interconnected with a first fluid inlet manifold which in turn, is interconnected with a first plurality of fluid filtration columns. The first plurality of fluid filtration columns is interconnected with a first fluid outlet manifold. Each of the plurality of fluid filtration columns has a first valve for controlling fluid inflow from the first fluid inlet manifold and a second valve for controlling fluid outflow into the first fluid outlet manifold. A second bypass line is interconnected with a second fluid inlet manifold which in turn, is interconnected with a second plurality of fluid filtration columns, said second plurality of fluid filtration columns interconnected with the first fluid outlet manifold. Each of the second plurality of fluid filtration columns has a first valve for controlling fluid inflow from the second fluid inlet manifold and a second valve for controlling fluid outflow into the first fluid outlet manifold.

Another embodiment of the present disclosure pertains to a multistage, multicolumn fluid filtration assembly comprising a first multicolumn fluid filtration assembly of the present disclosure and a second multicolumn fluid filtration assembly of the present disclosure that are adapted to be operably connected to each other. Each fluid outlet manifold of the first fluid filtration assembly is interconnected with one or more bypass lines of the second fluid filtration assembly and to each fluid outlet manifold of the second fluid filtration assembly. Each fluid inlet manifold of the first fluid filtration assembly is interconnected with a fluid inlet manifold of the second fluid filtration assembly. A valve for controlling fluid inflow is interposed the fluid outlet manifold of the first fluid filtration assembly and each bypass line of the second fluid filtration assembly interconnected therewith, the fluid outlet manifold of the first fluid filtration assembly and the fluid outlet manifold of the second fluid filtration assembly, and each fluid inlet manifold of the fluid filtration assembly and the fluid inlet manifold of the second fluid filtration assembly interconnected therewith.

The multistage, multicolumn filtration assemblies therefore comprise a first stage (e.g. a first multi-column filtration assembly) and a second stage (a second multi-column filtration assembly) that are operable either simultaneously, individually, or sequentially by manipulation of the valves interposed the components of the first stage interconnected with the second stage. That is, fluid may be fed to the first stage and then to the second stage, to the first stage only, to the second stage only, or to both stages simultaneously. As well, the first and second stages may be configured to include different pluralities of fluid filtration columns relative to each other. For example, the second stage may be configured to filter finer contaminants than the first stage.

Another embodiment of the present disclosure pertains to a fluid treatment system that comprises a multicolumn filtration assembly of the present disclosure operably connected to one or more additional fluid processing equipment. In operation of such embodiments, the fluid is first filtered by the multicolumn filtration assembly and then provided to the additional fluid processing equipment for further treatment. The system may be skid-mounted on one or more skids.

### BRIEF DESCRIPTION OF THE DRAWINGS

Embodiments of the present disclosure will be described in conjunction with reference to the following drawings, in which:

FIG. 1 is a perspective view of an example of a multicolumn filtration assembly according to an embodiment of the present disclosure;

FIG. 2 is a front view of the multicolumn filtration assembly shown in FIG. 1;

FIG. 3 is an end view of the multicolumn filtration assembly shown in FIG. 1;

FIG. 4 is a perspective view of an individual filtration column from the assembly shown in FIG. 1;

FIG. 5 is a perspective view of a multicolumn filtration assembly according to another embodiment of the present disclosure, wherein the assembly is mounted onto a transportable skid having a containment tray housing around the perimeter of the assembly;

FIG. 6 is a perspective view of the transportable skid shown in FIG. 5;

FIG. 7 is a perspective view of another embodiment of the present disclosure wherein a multicolumn filtration assembly is mounted onto a transportable skid and enclosed in a modular building envelope accessible by a portable staircase;

FIG. 8 is a cross-sectional end view of another embodiment of the present disclosure wherein the multicolumn filtration assembly comprises two fluid filtration banks in communication with a single supply of fluid and having a single fluid outlet manifold;

FIG. 9 is a top view of an example of a multiphase, multicolumn filtration assembly according to an embodiment of the present disclosure; and

FIG. 10 is a schematic of a fluid treatment system according to an embodiment of the present disclosure.

### DETAILED DESCRIPTION

The embodiments of the present disclosure generally relate to multicolumn fluid filtration apparatus and assemblies that can be operated continuously to clean-up and polish untreated or primary-treated fluids captured and collected from various industrial operations. The embodiments disclosed herein are particularly suitable for, for example, high-volume continuous throughput of fluid collected and captured from hydraulic fracking operations, fluid collected and captured from steam-assisted gravity drainage (SAGD) operations, fluid captured and collected from mining operations, fluid captured and collected from agricultural operations, or fluid that has been contaminated as a result of destruction caused by a natural disaster. The fluid may be, for example and without limitation, wastewater, freshwater (e.g. lake water), contaminated water, turbid water, primary-treated produced water, or tailings.

One embodiment disclosed herein pertains to a multicolumn fluid filtration assemblies that comprise at least (i) a manifold system comprising a fluid inlet tee element connected to a bypass line interconnected with a fluid inlet manifold, and a fluid outlet manifold, (ii) a plurality of fluid filtration columns wherein each of the fluid filtration columns is connected at one end with the fluid inlet manifold, and at the other end with the fluid outlet manifold. A manifold valve is provided at the juncture of the fluid tee element and the fluid outlet manifold for use to controllably direct the incoming flow of fluid into the bypass line connected to the fluid inlet manifold, or alternatively into the fluid outlet manifold. Each fluid filtration column is provided with a first valve (inflow valve) at its juncture with the fluid inlet manifold and a second valve (outflow valve) at its juncture with the fluid outlet manifold. The present fluid filtration columns are suitably dimensioned and configured to receive therein a suitable filter cartridge of the type that is commonly used with filter pots. The fluid filtration columns may also be configured as a multi-pot unit, with each fluid filtration column containing, for example, up to 24 filter cartridges. In a further example, each multi-pot fluid filtration column may be configured to contain two or three or four or five or six or seven or eight or nine or ten filter cartridges. In an alternative example, each multiple-pot fluid filtration column may be configured to contain eleven or twelve or thirteen or fourteen or sixteen or seventeen or eighteen or nineteen or twenty or twenty-one or twenty-two or twenty-three or twenty-four filter cartridges. Such configurations may provide increased filtering efficiency as well as longevity of the filter cartridges. Examples of suitable filter cartridges include those available from Clean Harbors Inc. through their distribution outlets known as JL Filtration Inc., from ESG Filtration Ltd., from ISI Water, and the like.

When a multicolumn fluid filtration assembly according to the present disclosure is interconnected to a supply of fluid (e.g. primary-treated wastewater) and to an outlet for the cleaned-up polished fluid, the manifold valve may be positioned to direct the flow of incoming fluid through the bypass line into the fluid inlet manifold. Each of the plurality of fluid filtration columns has its inflow and outflow valves in an open position. The incoming fluid flows from the fluid inlet manifold through the plurality of fluid filtration columns into the fluid outflow manifold after which, the cleaned-up and polished fluid flows out of the multicolumn fluid filtration assembly. While not necessary, it is suitable to provide flow rate meters at the inlet end and outlet end of each fluid filtration column to enable monitoring of filter cartridge performance and condition. When the rate of fluid flow through a fluid filtration column is impeded below a set threshold flowrate, the fluid filtration column can be taken offline and isolated by closing its inlet and outlet valves after which, the column cap may be removed, the used filter cartridge removed and replaced with a fresh cartridge. The column cap is then sealingly reengaged with the fluid filtration column, the inlet and outlet valves opened thereby bringing the serviced fluid filtration column back online to receive therethrough a supply of fluid.

It is within the scope of this disclosure to provide each fluid filtration column with a differential pressure gauge for monitoring the pressure changes in the fluid flowing into the fluid filtration column and fluid flowing out of the fluid filtration column. It is within the scope of the present disclosure to alternatively provide a pair of fluid-flow-rate sensors wherein a first sensor is positioned about the fluid inlet of the column and a second sensor is positioned about the fluid outlet of the column. The pair of fluid-flow-rate sensors may continuously transmit electronic data by wireless means or by wired means, to a monitoring device that may continuously record the rate of flow of fluid through the column. The monitoring device may be configured to provide visual and downloadable time-based reports and report summaries regarding changes in the rate of flow of fluid through the column. The monitoring device may also be configured to issue an alert if the rate of flow of fluid through the column falls below a set threshold level. The alert may be an audible alert, or an alert that is visible on an alert device provided on the column, or an alert that is transmitted to a portable receiver such as personal handheld device.

It is to be noted that as used herein, the term “plurality of fluid filtration columns” means two or more fluid filtration columns connected in parallel to the fluid inlet manifold and the fluid outlet manifold. For example, “plurality” may mean two or three or four or five or six or seven or eight or nine or ten or eleven or twelve or thirteen or fourteen or fifteen or sixteen or seventeen or eighteen or more fluid filtration columns each connected in parallel to the fluid inlet manifold and the fluid outlet manifold.

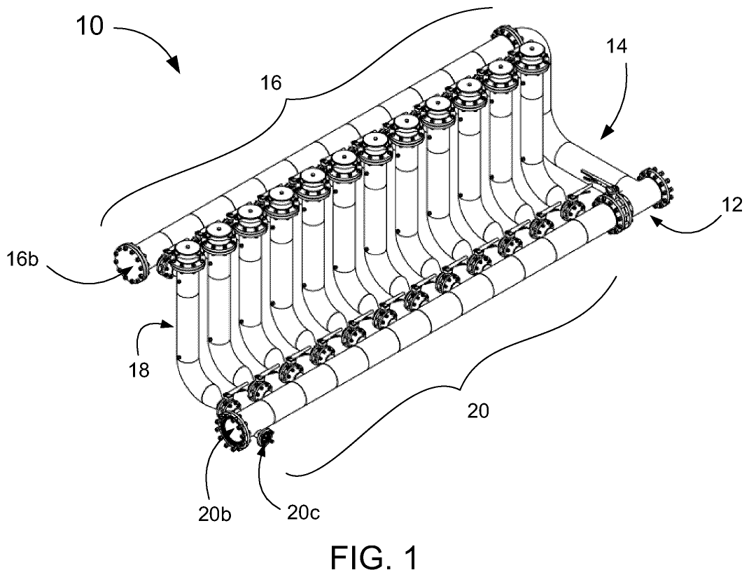

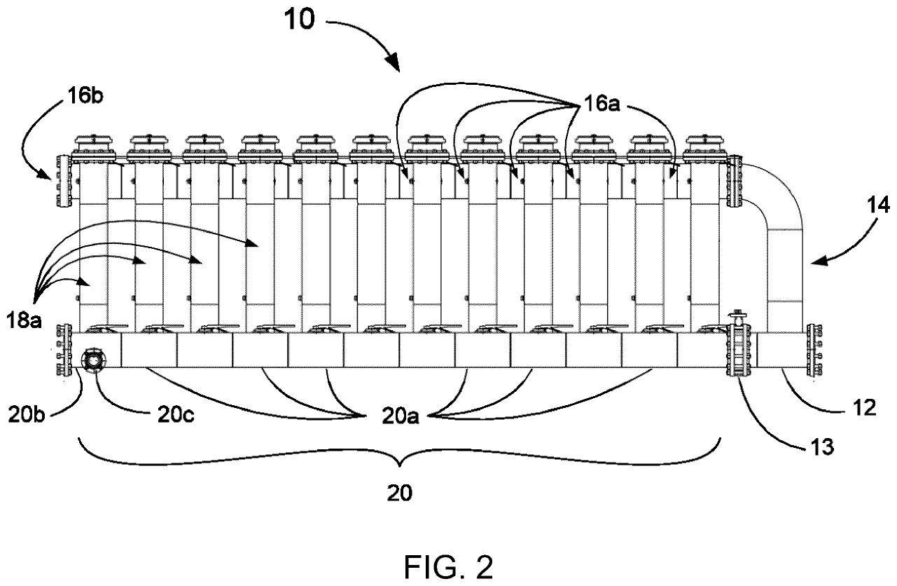

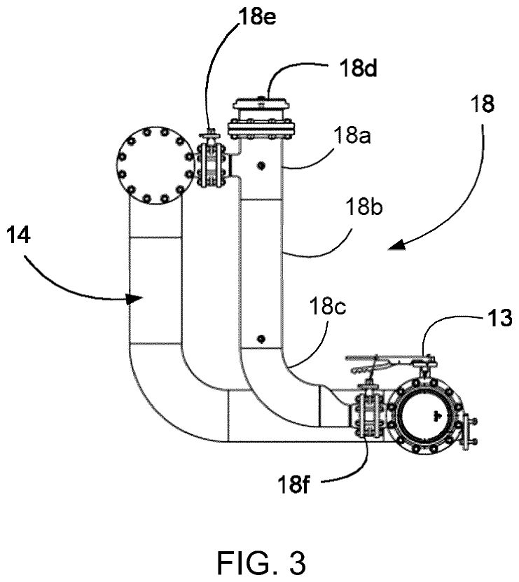

The configuration of a plurality of fluid filtration columns, each connected in parallel to the fluid inlet manifold and the fluid outlet manifold, allows continuous flow of, for example, primary-treated wastewater through the multicolumn fluid filtration assemblies disclosed herein whilst one or more individual fluid filtration columns are taken offline for service to remove and replace clogged filter cartridges thereby facilitating increased production of cleaned-up and polished fluid suitable for recycling and concurrently eliminating shut-downs to service filtration equipment during ongoing operations. An example of an embodiment of the present disclosure is illustrated in FIGS. 1-4 wherein a multicolumn fluid filtration assembly 10 comprises a 10″-dia. (25.4 cm dia.) tee element 12 connected to a bypass line 14 interconnected with a fluid inlet manifold 16, a fluid outlet manifold 20, and a valve 13 sealably interconnected between the 10″-dia. (25.4 cm dia.) tee element 12 and the fluid output manifold 20. A plurality of fluid filtration columns 18 is sealably interconnected with the fluid inlet manifold 16 and the fluid outlet manifold 20. The fluid inlet manifold 16 comprises multiple 10″-dia. (25.4 cm dia.) throughput tee elements 16a each having a 4″-dia. (10.2 cm dia.) output tee. The fluid outlet manifold 20 comprises multiple 10″-dia. (25.4 cm dia.) throughput tee elements 20a each having a 4″-dia. (10.2 cm dia.) output tee. Each of the fluid filtration columns 18a comprises 8″ (20.3 cm) piping 18b, 18c, interconnected at its top with an 8″-dia. (20.3 cm dia.) throughput tee element 18a having a 4″-dia. (10.2 cm dia.) input tee that is sealably connected a valve 18e that in turn is sealably connected to the 4″-dia. (10.2 cm dia.) output tee of a fluid inlet manifold tee 16a. The upper end of the fluid filtration column 8″-dia. (20.3 cm dia.) throughput tee element 18a is demountably engaged with a demountable nipple and cap assembly 18d. The lower end 18c of the fluid filtration column 18 is provided with a 4″ (10.2 cm) reducer that is sealably connected with a valve 18f that in turn, is sealably connected to the 4″-dia. (10.2 cm dia.) input tee of the 10″-dia. (25.4 cm dia.) fluid outlet throughput tee element 20a.

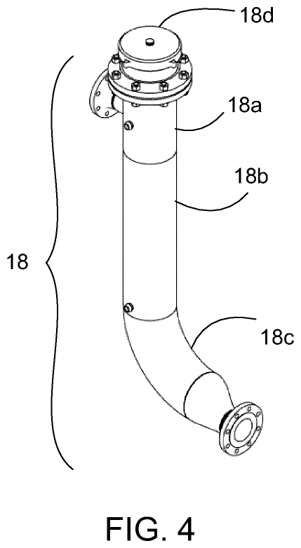

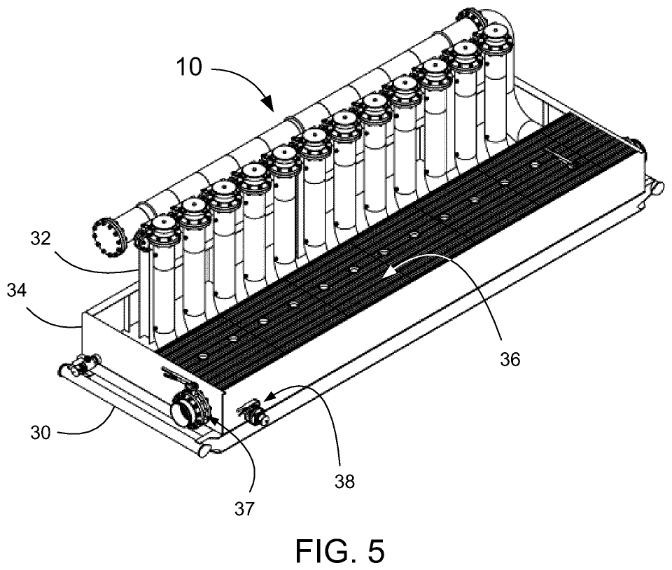

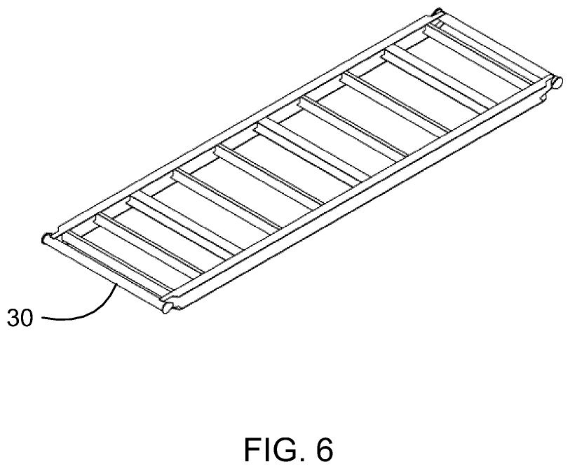

It is within the scope of the present disclosure to mount the multicolumn fluid filtration assemblies disclosed herein, onto transportable skids that are mountable onto the frameworks of heavy-duty over-the-road trucks or alternatively, onto the decks or frameworks of trailers towable by 1-ton trucks, heavier-duty trucks, and heavy-duty over-the-road truck tractors. An example of suitable transportable skids is illustrated in FIGS. 5-6. The multicolumn fluid filtration assembly 10 illustrated in FIGS. 1-4 is mounted onto a skid 30 and secured to the skid 30 with a plurality of spaced-apart support beams 32 (only one support beam 32 is illustrated in FIG. 5) securely engaged with the skid 30 and the fluid inlet manifold assembly 10. Skid mounting the fluid filtration assemblies of the present disclosure may allow for their transport to remote or difficult-to-access locations (e.g. oilfields, quarries, areas suffering infrastructure damage as a result of a natural disaster, etc.) with relative ease. As indicated above, the skid-mounted assemblies may be transported by truck. However, the skid-mounted assemblies may also be transportable by other methods such as by boat or by helicopter. A sheet metal perimeter housing 34 is provided to surround the lower portions of the fluid filtration columns 18 and the fluid outlet manifold 20. The perimeter housing 34 is provided with orifices through which the fluid supply line is sealably connected to the 10″-dia. (25.4 cm dia.) tee element 12 (not visible in FIG. 4) and a valve 37 that is sealably interconnected with the outlet of the fluid outlet manifold 20 (not visible in FIG. 5). A serrated metal grate 36 is mounted to and supported by the perimeter housing 34, for use as a walkway and work service for staff to use when servicing individual fluid filtration columns 18a (i.e., to remove and replace clogged filter cartridges).

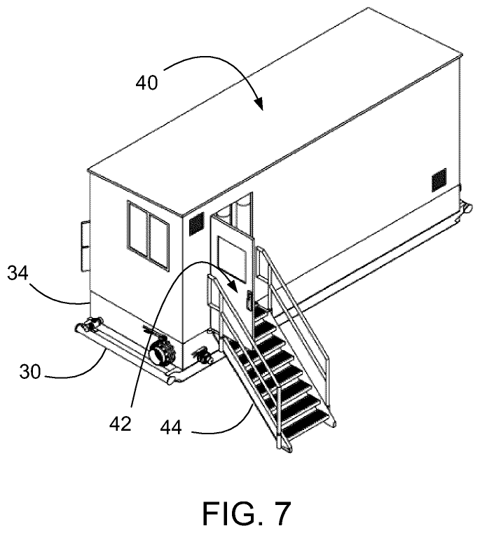

It is within the scope of the present disclosure to additionally provide enclosures engaged with the skids and perimeter housing into which the multicolumn fluid filtration assemblies disclosed herein are mounted. Suitable enclosures include external walls and roofing configured with polyurethane metal-clad panels Suitable polyurethane metal-clad panels are available from, for example, Metalex Metal Buildings Inc. (Stettler, AB, CA), A Better Panel Inc. (Innisfail AB, CA), Canalta Panels Lt.d (Vegreville, AB. CA). An example of a suitable enclosure 40 comprising 1½″ (3.81 cm) polyurethane metal-clad panels is illustrated in FIG. 7 and includes a door 42 that is accessible by way of a portable staircase 44 to enable a service technician to gain access to and work on the serrated metal grate 36 inside the enclosure 40.

It is to be noted that while the preceding example disclosed a multicolumn fluid filtration assembly having a single fluid inlet manifold and a single fluid outlet manifold interconnected with twelve fluid filtration columns, wherein one or more of the twelve fluid filtration columns may be separated, isolated and serviced while pressurized fluid flow is maintained through the remaining fluid filtration columns, it is within the scope of the present disclosure to provide less than twelve fluid filtration columns. For example, eleven or ten or nine or eight or seven or six or five or four or three or two fluid filtration columns. It is also within the scope of the present disclosure to provide more that twelve fluid filtration columns interconnecting the fluid inlet manifold and the fluid outlet manifold, for example thirteen or fourteen or fifteen or sixteen or seventeen or eighteen or more fluid filtration columns. Those skilled in this art will understand that a single fluid inlet manifold and a single fluid outlet manifold interconnected with twelve fluid filtration columns as described in the previous example, will conveniently fit onto a transportable skid provided with a perimeter housing and enclosure, that can be securely engaged to the framework of a heavy-duty over-the-road truck and alternatively, to a trailer deck towable by a heavy-duty over-the-road truck tractor.

Although the foregoing has been described in some detail by way of illustration and example for purposes of clarity of understanding, it is readily apparent to those of ordinary skill in the art in light of the teachings of the present disclosure that certain changes and modifications may be made thereto without departing from the spirit or scope of the appended claims.

For example, the preceding example illustrated one embodiment of the multicolumn fluid filtration assemblies disclosed herein having 10″-dia. (25.4 cm dia.) fluid throughput tees for the inlet and outlet manifolds, wherein the inlet and outlet manifolds are fitted with 4″-dia. (10.2 cm dia.) inlet and outlet tees for interconnection with 8″-dia. (20.3 cm dia.) fluid filtration columns fitted with 4″-dia. (10.2 cm dia.) inlet and outlet tees. However, those skilled in these arts will understand that smaller-scale multicolumn fluid filtration assemblies are possible. One example may have 8″-dia. (20.3 cm dia.) fluid throughput tees for the inlet and outlet manifolds, wherein the inlet and outlet manifolds are fitted with 4″-dia. (10.2 cm dia.) inlet and outlet tees for interconnection with 8″-dia. (20.3 cm dia.) fluid filtration columns fitted with 4″-dia. (10.2 cm dia.) inlet and outlet tees. Alternatively, the 8″-dia. (20.3 cm dia.) water throughput tees for the inlet and outlet manifolds may be fitted with 3″-dia. (7.62 cm dia.) inlet and outlet tees for interconnection with fluid filtration columns having 3″-dia. (7.62 cm dia.) inlet and outlet tees. Another example may have 6″-dia. (15.2 cm dia.) fluid throughput tees for the inlet and outlet manifolds, wherein the inlet and outlet manifolds are fitted with 3″-dia. (7.62 cm dia.) inlet and outlet tees for interconnection with 6″-dia. (15.2 cm dia.) fluid filtration columns fitted with 3″-dia. (7.62 cm dia.) inlet and outlet tees.

Those skilled in these arts will understand that fluid will have to be pumped into the multicolumn fluid filtration assembly under pressure. The pumps may be stationary or transportable. Examples of suitable pumps include (i) 6″×6″ (15.2 cm×15.2 cm) 127 HP pumps that provide flowrates of 7 m³/min, (ii) 8″×6″ (20.3 cm×15.2 cm) 550 HP pumps that provide flowrates of 12 m³/min, (iii) 10″×8″ (25.4 cm×20.3 cm) 375 HP that provide flowrates of 12 m³/min.

It is also to be noted that while the preceding example illustrated in FIGS. 1-7 described an assembly having a single fluid inlet interconnected with a bypass line and a single fluid inlet manifold and a single fluid outlet manifold with a plurality of fluid filtration columns separately communicating with the fluid inlet manifold and the fluid manifold and wherein each individual fluid filtration column may be individually shutdown and serviced while fluid flow is continuously flowing through the remaining plurality of fluid filtration columns, other configurations of fluid inlet manifolds and fluid outlet manifolds interconnected with pluralities of fluid filtration columns, are within the scope of the present disclosure.

Another embodiment of the present disclosure relates to a multicolumn fluid filtration assembly having a pair of fluid inlet manifolds and a pair of fluid outlet manifolds interconnected with pluralities of fluid filtration columns. One example comprises a single fluid inlet tee that is connected to two bypass lines wherein each bypass line is interconnected with a separate fluid inlet manifold. Each separate fluid inlet manifold is interconnected with a plurality of fluid filtration columns that are connected with a corresponding fluid outlet manifold, i.e., two sets of fluid inlet and outlet manifolds. In this example, each set of inlet/outlet manifolds is interconnected, preferably, by six fluid filtration columns. However, each set of inlet/outlet manifolds may be interconnected by five or four or three or two fluid filtration columns. Alternatively, each set of inlet/outlet manifolds may be interconnected by seven or eight or nine or more fluid filtration columns. One example comprises a single fluid inlet tee that is connected to two bypass lines wherein each bypass line is interconnected with a separate fluid inlet manifold. Each separate fluid inlet manifold is interconnected with a plurality of fluid filtration columns that are connected with a corresponding fluid outlet manifold, i.e., two sets of fluid inlet and outlet manifolds. In this example, each set of inlet/outlet manifolds is interconnected, preferably, by six fluid filtration columns. However, each set of inlet/outlet manifolds may be interconnected by five or four or three or two fluid filtration columns. Alternatively, each set of inlet/outlet manifolds may be interconnected by seven or eight or nine or more fluid filtration columns. Another example comprises a single fluid inlet tee that is connected to three bypass lines wherein each bypass line is interconnected with a separate fluid inlet manifold. Each separate fluid inlet manifold is interconnected with a plurality of fluid filtration columns that are connected with a corresponding fluid outlet manifold, i.e., three sets of water inlet and outlet manifolds. In this example, each set of inlet/outlet manifolds is interconnected, preferably, by four fluid filtration columns. However, each of the three sets of inlet/outlet manifolds may be interconnected by three or two fluid filtration columns. Alternatively, each of the three sets of inlet/outlet manifolds may be interconnected by five or six or more fluid filtration columns.

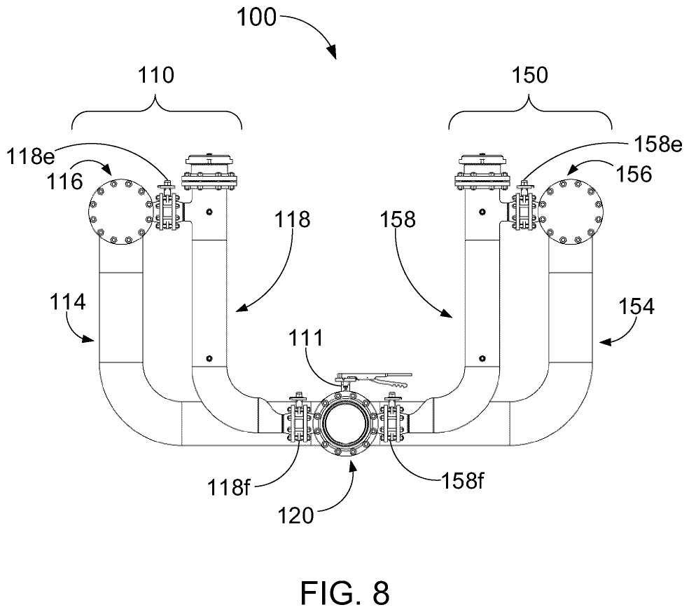

It is within the scope of this disclosure to configure a multicolumn fluid filtration assembly receiving a supply of fluid, with two fluid inlet manifolds and a single fluid outlet manifold wherein each of the fluid inlet manifolds is interconnected to the fluid outlet manifold with a plurality of fluid purification columns. An example of this embodiment is illustrated in FIG. 8 and comprises a multicolumn fluid filtration assembly 100 having two fluid filtration banks 110, 150 wherein the first fluid filtration bank 110 is interconnected with the incoming supply of fluid by a first bypass line 114. The first bypass line 114 is sealably connected to a first fluid intake manifold 116 which in turn, is sealably interconnected with a plurality of first fluid filtration columns 118. Each of the first fluid filtration columns is configured as described for the fluid filtration columns 18 disclosed in reference to FIGS. 1-4, and is provided with a first valve 118e that is sealably engaged with the first fluid intake manifold 116 and a second valve 118f that is sealably engaged with a fluid outlet manifold 120. The second fluid filtration bank 150 is interconnected with the incoming supply of fluid by a second bypass line 154. The second bypass line 114 is sealably connected to a second fluid intake manifold 156 which in turn, is sealably interconnected with a plurality of second fluid filtration columns 158. Each of the second fluid filtration columns 158 is configured as described for the fluid filtration columns 18 disclosed in reference to FIGS. 1-4, and is provided with a second valve 158e that is sealably engaged with the second fluid intake manifold 156 and a second valve 158f that is sealably engaged with the fluid outlet manifold 120. The incoming supply of fluid is sealably engaged with a tee (not visible in FIG. 8) provided with a valve 111 that may be operated to concurrently deliver the supply of fluid to both bypass lines 114, 154 or alternatively, to one bypass line only. Each fluid inlet manifold 116, 156 may be sealably engaged with two or three or four or five or six or seven or eight or more fluid filtration columns 118, 158 that in turn, are sealably engaged with the fluid outlet manifold 120. This configuration enables shutting off the flow of fluid to one of the two fluid filtration banks 110, 150 to enable service of all of the fluid filtration columns in the shut off fluid filtration bank while the other fluid filtration bank remains in operation. This configuration also enables isolation and service of a single fluid filtration column while the remaining fluid filtration columns of both fluid filtration banks 110, 150 remain in operation.

It is noted that the pipes used in the assemblies of the present disclosure may be of any suitable diameter. In some configurations, the pipes have a diameter in the range of 2″ (5.08 cm) to 36″ (91.4 cm). For example, the pipes may have a diameter of 2″ (5.08 cm) or 3″ (7.62 cm) or 4″ (10.2 cm) or 6″ (15.2 cm) or 8″ (20.3 cm) or 10″ (25.4 cm) or 12″ (30.5 cm) or 14″ (35.6 cm) or 16″ (40.6 cm) or 18″ (45.7 cm) or 20″ (50.8 cm) or 22″ (55.9 cm) or 24″ (61.0 cm) or 26″ (66.0 cm) or 28″ (71.1 cm) or 30″ (76.2 cm) or 32″ (81.3 cm) or 36″ (91.4 cm). Further, it is optional for the configurations described herein, if so desired, to provide a fluid outlet manifold having a larger internal diameter than the diameters of the fluid inlet diameters. For example, if the fluid inlet manifold diameters are 10″ (25.4 cm), then the fluid outlet manifold may have a diameter of 12″ (30.5 cm) or 14″ (35.6 cm) or 16″ (40.6 cm). If the fluid inlet manifold diameters are 8″ (20.3 cm), then the fluid outlet manifold may have a diameter of 10″ (25.4 cm) or 12″ (30.5 cm) or 14″ (35.6 cm). If the fluid inlet manifold diameters are 6″ (15.2 cm), then the fluid outlet manifold may have a diameter of 8″ (20.3 cm) or 10″ (25.4 cm) or 12″ (30.5 cm).

It is also within the scope of this disclosure to configure a multistage, multicolumn fluid filtration assembly. The multistage, multicolumn fluid filtration assembly may a first multicolumn fluid filtration assembly (i.e. a first stage) and a second multicolumn fluid assembly (i.e. a second stage). The first and second multicolumn fluid assemblies may have any configuration previously disclosed herein (e.g. any number of bypass lines, fluid inlet manifolds, fluid filtration columns, fluid outlet manifolds, fitting and pipe sizes, etc.), while being adapted to operatively connect to each other.

The first and second multicolumn fluid filtration assemblies may be operatively connected to the second multicolumn fluid filtration assembly using a variety of configurations. For example, each fluid outlet manifold of the first multicolumn fluid filtration assembly may be separately interconnected with a corresponding fluid outlet manifold of the second multicolumn fluid filtration assembly. As well, each fluid outlet manifold of the first multicolumn fluid filtration assembly may also be interconnected with one or more bypass lines of the second multicolumn fluid filtration assembly. Each plurality of fluid filtration columns is interconnected with the fluid outlet manifold(s) of the second multicolumn fluid filtration assembly. A valve for controlling the inflow of fluid may interpose components of the first multicolumn fluid filtration assembly interconnected with the second multicolumn fluid filtration assembly that are interconnected.

In such configurations of multistage, multicolumn fluid filtration assemblies, the fluid may be selectively allowed to pass through the first and second stages using valves interposed the first multicolumn fluid filtration assembly and the second multicolumn fluid filtration assembly. For example, the incoming fluid may be filtered in the first stage and subsequently filtered in the second stage, or may optionally be sent directly to the fluid outlet manifold(s) of the second stage without filtering. Alternatively, incoming fluid may instead be sent directly to the fluid outlet manifold(s) of the first stage and filtered only in the second stage.

Further, the multistage, multicolumn fluid filtration assemblies of the present disclosure may also be configured such that each fluid inlet manifold of the first multicolumn fluid filtration assembly is separately interconnected with a corresponding fluid inlet manifold of the second multicolumn fluid filtration assembly. A valve for controlling the inflow of fluid may interpose fluid inlet manifolds of the first multicolumn fluid filtration assembly that are interconnected with those the fluid inlet manifolds of the second multicolumn fluid filtration assembly. Such configurations may allow the first stage and the second stage of the multistage, multicolumn fluid filtration assembly to selectively operate as a single-stage fluid filtration assembly. For example, incoming fluid may flow, to the fluid inlet manifold(s) of the first stage and subsequently to the fluid inlet manifold(s) of the second stage. Thus, the fluid, by way of the fluid inlet manifolds of the first and second stages, may be filtered through the plurality of fluid filtration columns of both the first and second stage simultaneously such that the multistage, multicolumn filtration assembly operates as a single-stage assembly.

The multistage, multicolumn fluid filtration assemblies of the present disclosure may therefore comprise multiple stages that are selectively operable simultaneously, individually, or sequentially. For example, fluid may be fed to the first stage and then to the second stage, to the first stage only, to the second stage only, or to the first and second stages simultaneously.

Further, as will be appreciated, the first and second stages of the multistage, multicolumn fluid filtration assemblies may be outfitted with different pluralities of fluid filtration columns. For example, the first stage may be configured for the filtration of coarse particles, while the second stage is configured for the filtration of fine particles.

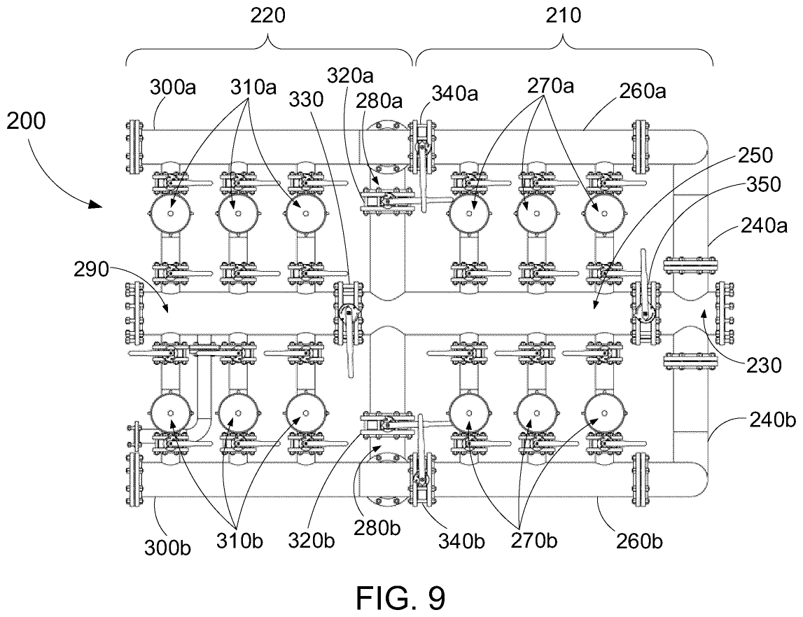

For greater clarity, an example multistage, multicolumn fluid filtration assembly 200 is illustrated in FIG. 9. The multistage, multicolumn fluid filtration assembly 200 is a two-stage filtration assembly comprising a first stage 210 and a second stage 220. The first stage includes a fluid inlet tee 230 that is connected to bypass lines 240a, 240b and by way of a valve 350 to a first outlet manifold 250. Each of the bypass lines 240 are connected to separate inlet manifolds 260a, 260b, which are in turn each connected to a plurality of fluid filtration columns 270a, 270b. The plurality of fluid filtration columns are connected to the first outlet manifold 250.

The first stage 210 is connected to the second stage 220 by way of the first fluid outlet manifold 250 and the fluid inlet manifolds 260a, 260b. In more detail, the first fluid outlet manifold 250 is connected by way of valves 320a, 320b to bypass lines 280a, 280b of the second stage 220 as well as to a second fluid outlet manifold 290 of the second stage 220 by way of a valve 330. As well, the fluid inlet manifolds 260a, 260b each connected by way of valves 340a, 340b to fluid inlet manifolds 300a, 300b, respectively, of the second stage 220.

The second stage 220 of the multistage, multicolumn fluid filtration assembly 200 is configured in a similar manner to the first stage 210. That is, each of fluid inlet manifolds 300a, 300b are connected to a plurality of fluid filtration columns 310a, 310b, which are in turn connected to the second fluid outlet manifold 290.

Thus, manipulation of the valves 320a, 320b, 330, 340a, 340b, and 350, allows for the selective use of the first stage 210 and second stage 220 of the multicolumn fluid filtration assembly 200. That is, the first stage first stage 210 and second stage 220 may be operated simultaneously, individually, or sequentially, as previously described herein.

Further, it is noted that while the present disclosure generally describes the multistage, multicolumn fluid filtration assembly as having two stages, the multistage, multicolumn fluid filtration may have more than two stages. For example, the multistage, multicolumn fluid filtration may comprise three or four or more stages, with each additional stage connected to a previous stage as described above.

Additionally, the multistage, multicolumn fluid filtration assembly may be sized so as to be capable of being skid-mounted and/or housed, in the same manner as the assemblies illustrated in FIGS. 5 and 7, in order to facilitate their transport.

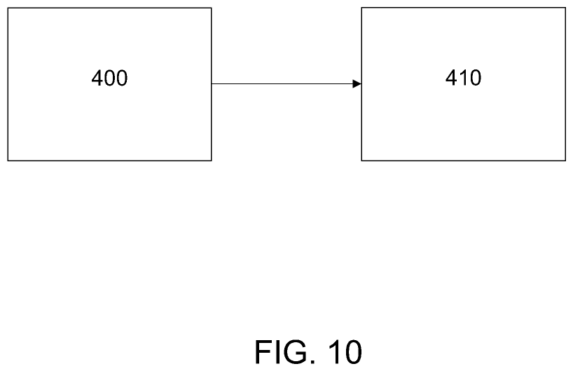

It is also within the scope of this disclosure to provide a fluid treatment system comprising a multicolumn fluid assembly of the present disclosure operably connected to one or more additional fluid processing equipment. For example, as illustrated in FIG. 10, a multicolumn fluid filtration assembly 400 may be interconnected to a reverse osmosis system 410. The multicolumn fluid filtration assembly 400 may be any assembly previously described herein and reverse osmosis systems are known in the art.

As will be appreciated, reverse osmosis systems are generally used for the purification of fluids. Thus, interconnecting the multicolumn fluid filtration assemblies of the present disclosure to a reverse osmosis system may be particularly useful for applications such as producing potable water after, for example, a natural disaster has rendered a source of water unfit for consumption. In operation, the multicolumn fluid filtration assemblies of the present disclosure may remove particulate matter from the contaminated water, while the reverse osmosis system may subsequently render the water potable.

Additionally, while a reverse osmosis system is illustrated, the additional fluid processing equipment may be any equipment, system, or apparatus that may further treat or process the filtered fluid. Other suitable equipment includes, for example, UV treatment systems, boilers, chemical treatment apparatus, and the like.

Furthermore, the additional fluid treatment or processing equipment (e.g. the reverse osmosis system) may also be mountable on skids to facilitate their transport. This may allow for relatively easy transport of the multicolumn fluid filtration systems of the present disclosure along with the additional treatment or processing equipment to a job site (e.g. a remote location or area affected by a natural disaster) for their deployment.

Thus, in view of the configurations described above, while the filtration assemblies of the present disclosure have been generally described in relation to industries such as oil and gas, mining, and agriculture, and for use in applications such as civil or natural disaster response, it will be appreciated that the assemblies may be used in a wide variety of industries and/or applications. That is, the assemblies may be used in any industry or application that may require the high-throughput filtration of a fluid.

It must be noted that as used in this specification and the appended claims, the singular forms “a”, “an”, and “the” include plural reference unless the context clearly dictates otherwise. Unless defined otherwise all technical terms used herein have the same meaning as commonly understood to one of ordinary skill in the art to which the present disclosure belongs.

The phrase “and/or”, as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to encompass the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items.

As used herein, whether in the specification or the appended claims, the transitional terms “comprising”, “including”, “having”, “containing”, “involving”, and the like are to be understood as being inclusive or open-ended (i.e., to mean including but not limited to), and they do not exclude unrecited elements, materials or method steps. Only the transitional phrases “consisting of” and “consisting essentially of”, respectively, are closed or semi-closed transitional phrases with respect to claims and exemplary embodiments herein. The transitional phrase “consisting of” excludes any element, step, or ingredient which is not specifically recited. The transitional phrase “consisting essentially of” limits the scope to the specified elements, materials or steps and to those that do not materially affect the basic characteristic(s) of the subject matter disclosed and/or claimed herein.

1. A multicolumn fluid filtration assembly, comprising:
a fluid inlet tee element interconnected with a bypass line and a fluid outlet manifold;
a valve interposed the fluid inlet tee element and the bypass line;
a fluid inlet manifold interconnected with the bypass line; and
a plurality of fluid filtration columns interposed the fluid inlet manifold and the fluid outlet manifold wherein each of the plurality of fluid filtration columns has a first valve for controlling fluid inflow from the fluid inlet manifold and a second valve for controlling fluid outflow into the fluid outlet manifold.

2. A multicolumn filtration assembly according to claim 1, wherein each of the plurality of fluid filtration columns is provided with a differential pressure gauge to detect a rate of flow out of the each of the plurality of fluid filtration columns.

3. A multicolumn filtration assembly according to claim 1, wherein each of the plurality of fluid filtration columns is provided with a pair of flow-rate sensors, wherein a first flow-rate sensor is configured to detect a rate of flow into and a second flow-rate sensor is configured to detect a rate of flow out of the each of the plurality of fluid filtration columns.

4. A multicolumn filtration assembly according to claim 1, wherein the multicolumn filtration assembly is mounted onto a transportable skid.

5. A multicolumn filtration assembly according to claim 4, wherein the transportable skid is provided with an enclosure for housing therein the multicolumn filtration assembly.

6. A multicolumn filtration assembly according to claim 1, wherein the fluid inlet tee element is sealably engaged with two bypass lines, wherein:
a first bypass line is interconnected with a first fluid inlet manifold, said first fluid inlet interconnected with a first plurality of fluid filtration columns, said first plurality of fluid filtration columns interconnected with a first fluid outlet manifold, wherein each of the plurality of fluid filtration columns has a first valve for controlling fluid inflow from the first fluid inlet manifold and a second valve for controlling fluid outflow into the first fluid outlet manifold;
a second bypass line is interconnected with a second fluid inlet manifold, said second fluid inlet interconnected with a second plurality of fluid filtration columns, said second plurality of fluid filtration columns interconnected with a second fluid outlet manifold, wherein each of the second plurality of fluid filtration columns has a first valve for controlling fluid inflow from the second fluid inlet manifold and a second valve for controlling fluid outflow into the second fluid outlet manifold;
a first valve is interposed the fluid inlet tee element and the first bypass line; and
a second valve is interposed the fluid inlet tee element and the second bypass line.

7. A multicolumn filtration assembly according to claim 1, wherein the fluid inlet tee element is interconnected with two bypass lines, wherein:
a first bypass line is interconnected with a first fluid inlet manifold, said first fluid inlet interconnected with a first plurality of fluid filtration columns, said first plurality of fluid filtration columns interconnected with a first fluid outlet manifold, wherein each of the plurality of fluid filtration columns has a first valve for controlling fluid inflow from the first fluid inlet manifold and a second valve for controlling fluid outflow into the first fluid outlet manifold;
a second bypass line is interconnected with a second fluid inlet manifold, said second fluid inlet interconnected with a second plurality of fluid filtration columns, said second plurality of fluid filtration columns interconnected with the first fluid outlet manifold, wherein each of the second plurality of fluid filtration columns has a first valve for controlling fluid inflow from the second fluid inlet manifold and a second valve for controlling fluid outflow into the first fluid outlet manifold;
a first valve is interposed the fluid inlet tee element and the first bypass line; and
a second valve is interposed the fluid inlet tee element and the second bypass line.

8. A multistage, multicolumn fluid filtration assembly, comprising:
a first fluid filtration assembly according to claim 1; and
a second fluid filtration assembly according to claim 1,
wherein the first and second fluid filtration assemblies are adapted to operably connect to each other in that the fluid outlet manifold of the first fluid filtration assembly is interconnected with the bypass line of the second first fluid filtration assembly and with the outlet manifold of the second first fluid filtration assembly, and in that the fluid inlet manifold of the first fluid filtration assembly is interconnected with the fluid inlet manifold of the second fluid filtration assembly; and
wherein a valve is interposed:
the fluid outlet manifold of the first fluid filtration assembly and the bypass line of the second first fluid filtration assembly;
the fluid outlet manifold of the first fluid filtration assembly and the outlet manifold of the second assembly; and
the fluid inlet manifold of the first fluid filtration assembly and the fluid inlet manifold of the second fluid filtration assembly.

9. A fluid treatment system comprising fluid filtration assembly according to claim 1 operably connected to one or more additional fluid treatment equipment.

10. The fluid treatment system of claim 9, wherein the one or more additional fluid treatment equipment comprises a reverse osmosis system.
